(19) United States
(12) Patent Application Publication
(10) Pub. No.: US 2022/0063112 A1
(43) Pub. Date: Mar. 3, 2022

(54) ROBOT HAND AND PICKING SYSTEM

(71) Applicant: HITACHI, LTD., Tokyo (JP)

(72) Inventors: Takaomi NISHIGAITO, Tokyo (JP); Hiroshige KASHIWABARA, Tokyo (JP); Tadashi OSAKA, Tokyo (JP); Hiroshi IKEDA, Tokyo (JP)

(73) Assignee: HITACHI, LTD., Tokyo (JP)

(21) Appl. No.: 17/203,107

(22) Filed: Mar. 16, 2021

(30) Foreign Application Priority Data
Aug. 27, 2020 (JP) 2020-143195

(51) Int. Cl. B25J 15/00; B25J 15/06; B25J 9/16; B65G 61/00

(52) U.S. Cl. CPC B25J 15/0052; B25J 15/0028; B65G 61/00; B25J 9/1633; B25J 15/0616

(57) ABSTRACT

A robot hand includes grip portions for gripping an article, grip drive mechanisms for moving the grip portions, and a control device for controlling the drive of the grip drive mechanisms. Then, the control device controls the drive of the grip drive mechanisms to start gripping operation with a first force for a force of gripping an article by the grip portions, and then switches the force of gripping an article by the grip portions to a second force.

### BACKGROUND OF THE INVENTION

### 1. Field of the Invention

The present invention relates to a robot hand that grips an article and a picking system including the robot hand.

### 2. Description of the Related Art

In recent years, there is known a picking system in which a transfer robot holds an article carried in from a process upstream of a predetermined place and carries out to a predetermined place. Further, the transfer robot is provided with a robot hand that grips an article.

As a technique relating to a robot hand that grips an article, for example, there is a technique as described in JP 2018-507116 A. JP 2018-507116 A describes a technique including a fingertip link, a base link, a plurality of bar finger link mechanisms, and an actuator that is connected to the base link and rotates the plurality of bar finger link mechanisms around the base link.

Further, some objects held by the robot hand have different thicknesses and some have different hardnesses. Then, when gripping a relatively soft article, the robot hand needs to grip the article so as not to damage the article. For this reason, in the technique described in JP 2018-507116 A, a pressure sensor is provided in a grip portion that grips an article.

### SUMMARY OF THE INVENTION

However, in the technique described in JP 2018-507116 A, the actuator is feedback-controlled based on a detection signal of the pressure sensor, and the force for gripping an object in the grip portion is controlled. For this reason, in the technique described in JP 2018-507116 A, the control of the grip portion and the actuator is very complicated.

An object of the present invention is to provide a robot hand and a picking system capable of gripping an article with a simple configuration in consideration of the above problem.

In order to solve the above problem and achieve the object, a robot hand includes a grip portion that grips an article, a grip drive mechanism that moves the grip portion, and a control device that controls the drive of the grip drive mechanism. Then, the control device controls the drive of the grip drive mechanism to start gripping operation with a first force for a force of gripping the article by the grip portion, and then switches the force of gripping the article by the grip portion to a second force.

Further, the picking system includes a transfer robot that conveys an article and a robot hand provided in the transfer robot. Further, as the robot hand, the above-mentioned robot hand is used.

According to the robot hand and the picking system having the above configuration, an article can be reliably gripped with a simple configuration.

### BRIEF DESCRIPTION OF THE DRAWINGS

FIG. 1 is a schematic configuration diagram illustrating a picking system according to an embodiment;

FIG. 2 is a perspective view illustrating a robot hand according to an embodiment;

FIG. 3 is a front view illustrating the robot hand according to an embodiment;

FIG. 4 is a front view illustrating a state in which the robot hand according to the embodiment is in operation;

FIG. 5 is a front view illustrating a state in which the robot hand according to the embodiment is sucking and gripping an article;

FIGS. 6A to 6D are explanatory views illustrating an operation example of the picking system according to the embodiment;

FIGS. 7A to 7C are explanatory views illustrating the operation example of the picking system according to the embodiment; and

FIGS. 8A to 8D are explanatory views illustrating another example of the operation example of the picking system according to the embodiment.

### DESCRIPTION OF THE PREFERRED EMBODIMENTS

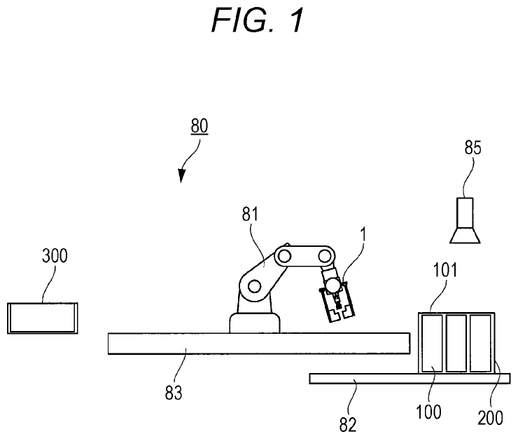

Hereinafter, an embodiment of the robot hand and the picking system will be described with reference to FIGS. 1 to 8D. Note that common members in the diagrams are designated by the same reference numerals.

### 1. Embodiment

### 1-1. Configuration Example of Picking System

First, a configuration of the picking system according to an embodiment (hereinafter referred to as the “present embodiment”) will be described with reference to FIG. 1. FIG. 1 is a schematic configuration diagram illustrating the picking system of the present embodiment.

As shown in FIG. 1, a picking system 80 includes a transfer robot 81, a carry-in conveyor 82 for carrying an article 100 to the transfer robot 81, a moving mechanism 83, a camera 85, and a carry-out container 300. The picking system 80 conveys the article 100 to the carry-out container 300. Further, the picking system 80 has a control device (not shown) that controls the transfer robot 81, the carry-in conveyor 82, the moving mechanism 83, the camera 85, and the like.

The transfer robot 81 is, for example, a vertical articulated robot having six-axis joints. An arm of the transfer robot 81 is provided with a robot hand 1 that sucks and grips the article 100. The details of the robot hand 1 will be described later.

The camera 85 is arranged above the position where the transfer robot 81 grips the article 100 by using the robot hand 1. The camera 85 photographs the article 100 carried in from the carry-in conveyor 82. Then, the camera 85 outputs the captured information to a control device (not shown). The control device determines information about the article 100 such as the position of the article 100 and the size of the article 100 based on the information acquired from the camera 85. Then, the control device controls the operation of the transfer robot 81 and the robot hand 1 based on the information about the article 100.

Note that, in the picking system 80 of the present embodiment, the example in which the camera 85 is provided above the position where the article 100 is gripped is described. However, the present invention is not limited to this. For example, the camera 85 may be provided on the transfer robot 81 or the robot hand 1, or may be arranged on the side or the like of the position where the article 100 is gripped.

Furthermore, the example in which the control device determines the size, type, and the like of the article 100 based on the information captured by the camera 85 is described. However, the present invention is not limited to this, and, for example, information about the size, type, and the like of the article 100 may be input to the control device in advance.

The transfer robot 81 is supported by the moving mechanism 83 in a manner movable in the uniaxial direction. The carry-in conveyor 82 is arranged on one side in the moving direction of the moving mechanism 83. The carry-in conveyor 82 conveys a storage cardboard 200 containing a plurality of the articles 100 from the process on the upstream side of the picking system 80 to a predetermined position.

The carry-out container 300 is arranged on the other side in the moving direction of the moving mechanism 83. The carry-out container 300 stores the article 100 carried out by the transfer robot 81. The example in which the transfer robot 81 is moved by the moving mechanism 83 is described. However, the present invention is not limited to this, and the transfer robot 81 itself may be provided with a moving mechanism, or the transfer robot 81 may be fixed.

Note that, the example in which the article 100 is stored in the carry-out container 300 is described as the picking system 80. However, the present invention is not limited to this. As the picking system 80, for example, the article 100 gripped by the robot hand 1 of the transfer robot 81 may be conveyed to a carry-out conveyor or stored in a storage shelf, and various other ones of the picking systems 80 are applied.

Further, the example in which a vertical articulated robot having six-axis joints is applied is described as the transfer robot 81. However, the present invention is not limited to this. As the transfer robot 81, a two-axis robot that rotates in the horizontal direction and moves in the vertical direction may be applied, and various other robots can be applied.

### 1-2. Configuration Example of Robot Hand

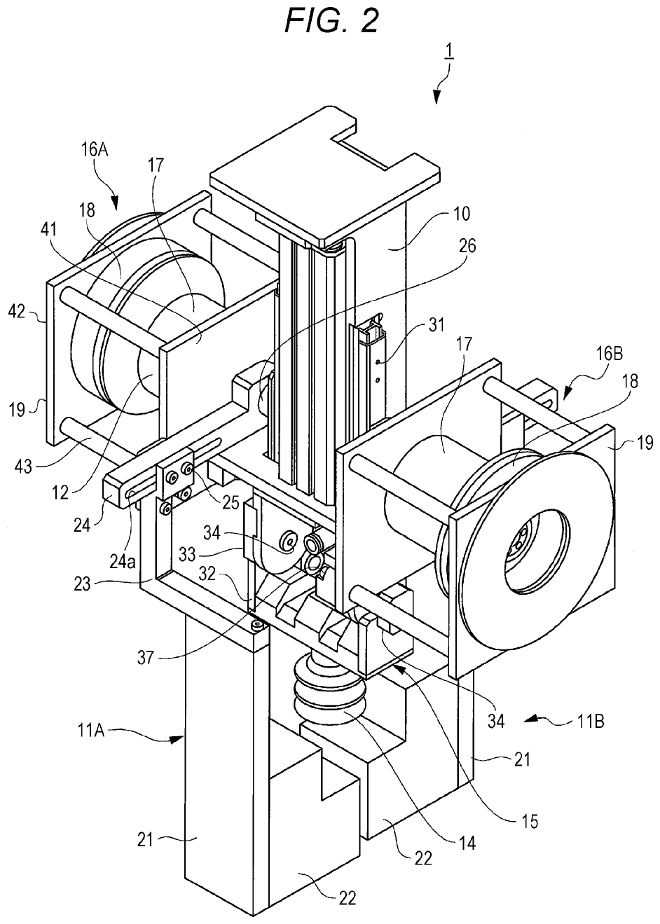

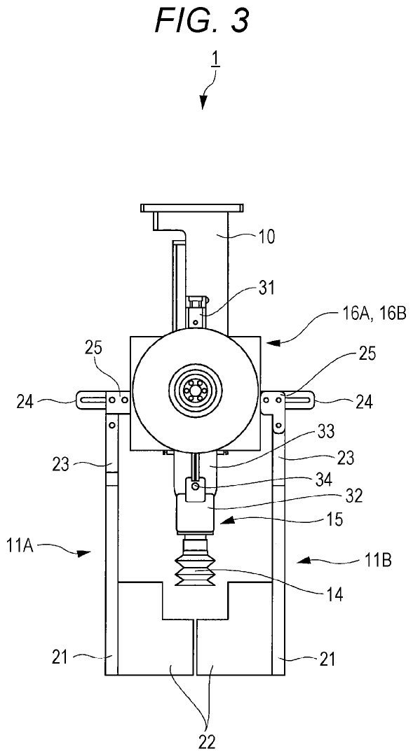

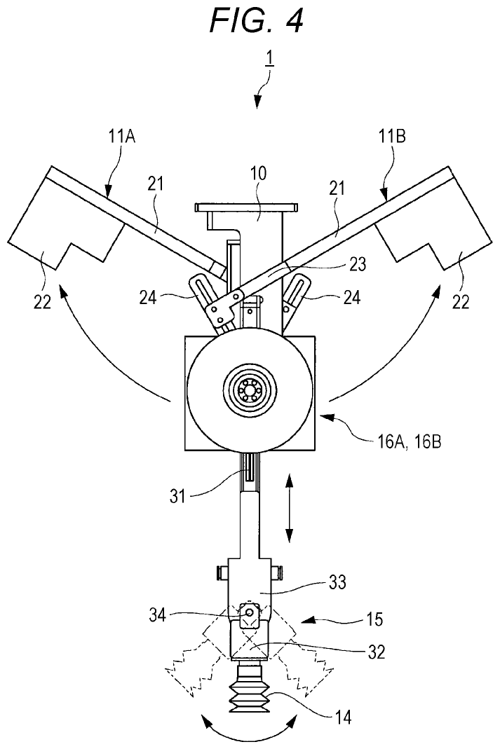

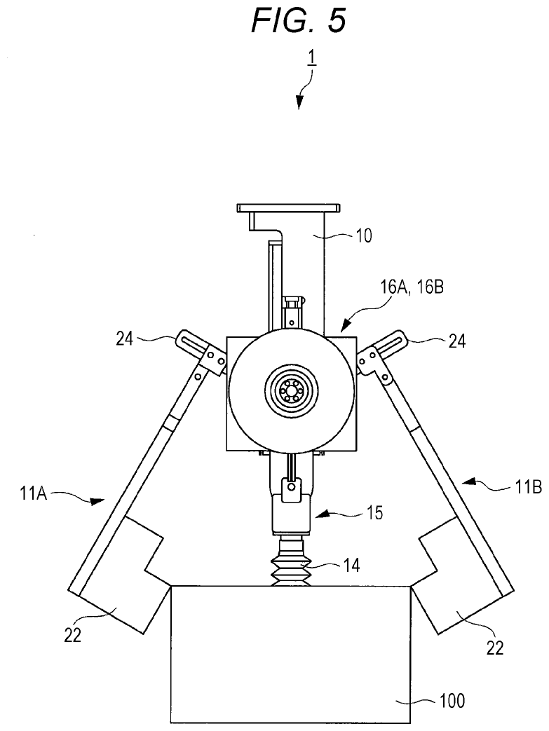

Next, a detailed configuration of the robot hand 1 provided in the transfer robot 81 will be described with reference to FIGS. 2 to 5. FIG. 2 is a perspective view illustrating the robot hand 1, and FIG. 3 is a front view illustrating the robot hand 1. FIG. 4 is a front view illustrating a state in which the robot hand 1 is driven, and FIG. 5 is a front view illustrating a state in which the robot hand 1 sucks and grips the article 100.

As shown in FIGS. 2 and 3, the robot hand 1 has a main body portion 10 attached to the transfer robot 81, two grip portions 11A and 11B, a suction pad 14, an extension/contraction arm 15, and two grip drive mechanisms 16A and 16B.

The extension/contraction arm 15 is provided on the side of the main body portion 10 opposite to a base end portion attached to the robot hand 1, that is, on a tip portion. The extension/contraction arm 15 has a guide rail 31, a swing portion 32, an extension/contraction portion 33, a swing shaft 34, a swing actuator 37, and a cylinder (not shown). As the swing actuator 37, for example, a rotary actuator is applied.

The guide rail 31 is provided on a side surface portion of the main body portion 10. Then, the guide rail 31 extends along the longitudinal direction, which is the direction from the base end portion to the tip portion of the main body portion 10. The extension/contraction portion 33 is movably supported on the guide rail 31.

As shown in FIG. 4, the extension/contraction portion 33 expands and contracts along the longitudinal direction of the main body portion 10 by a cylinder provided inside the main body portion 10. Note that the example in which the extension/contraction portion 33 is expanded and contracted by the cylinder is described. However, the present invention is not limited to this, and for example, other various expansion and contraction mechanisms such as a linear actuator, a gear, and a motor may be applied.

The swing portion 32 is swingably attached to an end portion on the opposite side to the main body portion 10, that is, a tip portion of the extension/contraction portion 33 with the swing shaft 34 interposed between them. Further, when the swing actuator 37 is not driven, that is, in the OFF state, the swing portion 32 is in a state where the swing portion 32 can swing freely with respect to the swing shaft 34. Then, when the swing actuator 37 is driven, the swing portion 32 swings around the swing shaft 34, and the swing angle with respect to the extension/contraction portion 33 is maintained. Note that the swing angle with respect to the extension/contraction portion 33 of the swing portion 32 is set by the control device controlling the drive of the swing actuator 37. Further, a suction pad 14 is provided in an end portion on the opposite side to the extension/contraction portion 33, that is, a tip portion of the swing portion 32.

The suction pad 14 is formed in a bellows shape by a flexible member. A negative pressure generator (not shown) is connected to the suction pad 14. When the suction pad 14 comes into contact with the article 100 and the negative pressure generator is driven, the suction pad 14 sucks the article 100 as shown in FIG. 5.

As shown in FIGS. 2 and 3, the first grip drive mechanism 16A is provided on a side surface portion of the main body portion 10. Further, the second grip drive mechanism 16B is provided on a side surface portion on the opposite side to the side surface portion provided with the first grip drive mechanism 16A of the main body portion 10. Since the first grip drive mechanism 16A and the second grip drive mechanism 16B have the same configuration, the first grip drive mechanism 16A will be described here.

The first grip drive mechanism 16A has a gripping actuator 17 indicating a drive unit, an electromagnetic brake 18 indicating a locking mechanism, and a case 19. The case 19 has a first support plate 41, a second support plate 42, and a connection portion 43. The first support plate 41 is fixed to the side surface portion of the main body portion 10. The second support plate 42 faces the first support plate 41 at a distance. Then, the first support plate 41 and the second support plate 42 are connected by the connection portion 43.

The gripping actuator 17 and the electromagnetic brake 18 are arranged between the first support plate 41 and the second support plate 42. The gripping actuator 17 is fixed to the first support plate 41, and the electromagnetic brake 18 is fixed to the second support plate 42. A rotary actuator is applied to the gripping actuator 17. Further, a rotation shaft 26 of the first grip portion 11A, which will be described later, is connected to one end portion of a drive shaft of the gripping actuator 17. The rotation shaft 26 is attached to the first support plate 41.

Further, the electromagnetic brake 18 is provided in the other end portion of the drive shaft of the gripping actuator 17. When driven, the electromagnetic brake 18 locks the drive shaft of the gripping actuator 17 at an optional rotation angle. In the present embodiment, the driving force of the gripping actuator 17 corresponds to the first force, and the force by which the electromagnetic brake 18 locks the drive shaft of the gripping actuator 17 corresponds to the second force.

The example in which the electromagnetic brake 18 is used to lock the rotation of the gripping actuator 17 is described. However, the present invention is not limited to this. For example, a ratchet mechanism, a fixing pin for fixing the rotation (movement) of the grip portions 11A and 11B described later, and various other locking mechanisms may be applied.

The grip drive mechanisms 16A and 16B support the grip portions 11A and 11B in a manner that the grip portions 11A and 11B are openable and closable. Specifically, the first grip portion 11A is attached to the first grip drive mechanism 16A, and the second grip portion 11B is attached to the second grip drive mechanism 16B. Since the first grip portion 11A and the second grip portion 11B have the same configuration, the first grip portion 11A will be described here.

The first grip portion 11A has an arm 21, a finger portion 22, an arm support portion 23, a rotation portion 24, and a rotation shaft 26. As described above, the rotation shaft 26 is connected to the drive shaft of the gripping actuator 17. The rotation portion 24 is rotatably connected to the rotation shaft 26.

The rotation portion 24 projects in an orthogonal direction from the axial direction of the rotation shaft 26. A slit 24a is formed in the rotation portion 24. The slit 24a is formed in a second end portion on the side opposite to a first end portion connected to the rotation shaft 26 of the rotation portion 24. Then, the slit 24a extends from the second end portion to the first end portion with a predetermined length. An adjusting screw 25 is attached to the slit 24a so that the arm support portion 23 can be moved. Then, by tightening the adjusting screw 25, the arm support portion 23 can be fixed at an optional position with respect to the slit 24a.

The arm support portion 23 is formed of a substantially L-shaped member. A tip portion on the opposite side to the connecting location of the rotation portion 24 of the arm support portion 23 is bent in a direction away from the rotation portion 24. Then, tip portions of the arm support portions 23 in the first grip portion 11A and the second grip portion 11B face each other with the extension/contraction arm 15 interposed between them. The arm 21 is fixed to the tip portion of the arm support portion 23.

The arm 21 projects from the tip portion of the arm support portion 23 in a direction away from the rotation portion 24. The finger portion 22 that comes into contact with the article 100 is provided in the tip portion of the arm 21. The finger portion 22 is formed of a flexible member such as rubber or sponge. This makes it possible to prevent the article 100 from being damaged when the finger portion 22 comes into contact with the article 100.

In the initial state shown in FIG. 3, the finger portions 22 of the first grip portion 11A and the second grip portion 11B are close to each other. Then, as shown in FIG. 4, when the gripping actuator 17 is driven, the rotation portion 24 rotates about the rotation shaft 26. As a result, the finger portions 22 of the first grip portion 11A and the second grip portion 11B are separated from each other. Further, as shown in FIG. 5, when the gripping actuator 17 is driven in the direction opposite to the direction shown in FIG. 4, the first grip portion 11A and the second grip portion 11B rotate in the directions in which the finger portions 22 approach each other. Then, the finger portions 22 of the first grip portion 11A and the second grip portion 11B come into contact with a side surface portion of the article 100. As a result, the article 100 can be gripped by the first grip portion 11A and the second grip portion 11B.

Further, by adjusting the attaching position of the arm support portion 23 to the slit 24a, the distance between the finger portion 22 of the first grip portion 11A and the finger portion 22 of the second grip portion 11B can be adjusted. In this manner, the distance between the finger portions 22 of the first grip portion 11A and the second grip portion 11B can be changed according to the size of the article 100.

Note that the example in which the arm support portion 23 is slid along the slit 24a provided in the rotation portion 24 to manually adjust the attaching position of the arm support portion 23 is described. However, the present invention is not limited to this. For example, the distance between the finger portions 22 may be adjusted in a manner that the arm support portion 23 is supported to be movable by a linear actuator, a motor, or the like with respect to the rotation portion 24 and the control device automatically changes the position of the arm support portion 23 according to the size of the article 100. Further, a plurality of the arm support portions 23 having different dimensions may be prepared, so that the arm support portion 23 is replaced with one another according to the size of the article 100.

Further, in the robot hand 1 of the present embodiment, the example in which the first grip portion 11A and the second grip portion 11B are rotated by the gripping actuator 17 to grip the article 100 is described. However, the present invention is not limited to this, and various other grip portion drive mechanisms can be applied. For example, as the grip portion drive mechanism, a drive mechanism that translationally move the first grip portion 11A and the second grip portion 11B to bring the finger portions 22 closer to and apart from each other may be applied. Therefore, the gripping actuator 17 indicating the drive unit is not limited to a rotary actuator, and for example, various other drive units such as a linear actuator and a pneumatic negative pressure generator may be applied.

Further, the example in which the finger portions 22 come in contact with the article 100 are provided in the tip portions of the arm 21 are provided on the grip portions 11A and 11B is described. However, the present invention is not limited to this. For example, the arm 21 itself may be composed of a flexible member, and the article 100 may be gripped by the arm 21, or the arm 21 may be composed of a plurality of link members. Various other configurations can be applied to the configurations of the grip portions 11A and 11B for gripping the article 100.

Furthermore, the number of grip portions provided on the robot hand 1 is not limited to two, and three or more grip portions may be provided.

### 2. Operation Example of Picking System

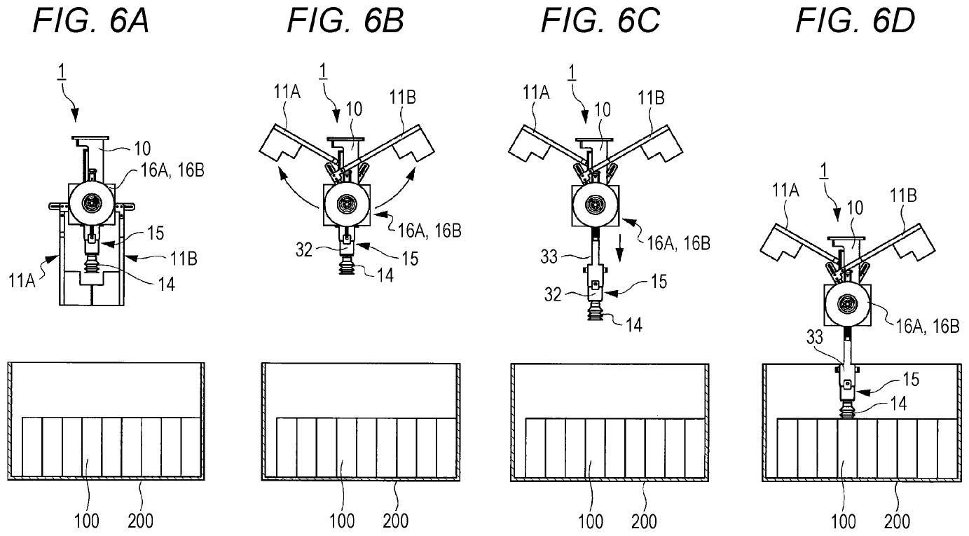

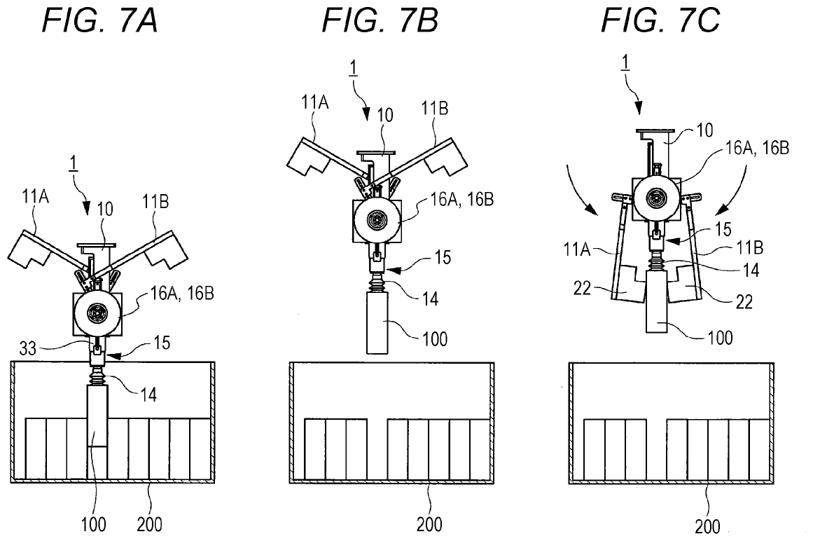

Next, an operation example of the picking system 80 having the above-described configuration will be described with reference to FIGS. 6A to 8D. FIGS. 6A to 7C are explanatory views showing an operation example of the picking system 80.

As shown in FIG. 6A, the control device first controls the transfer robot 81 (see FIG. 1) based on the information captured by the camera 85 (see FIG. 1) and moves the robot hand 1 to above an article to be gripped. Next, the control device drives the gripping actuators 17 of the grip drive mechanisms 16A and 16B of the robot hand 1. As a result, as shown in FIG. 6B, the first grip portion 11A and the second grip portion 11B open in a direction away from each other. Then, when the first grip portion 11A and the second grip portion 11B are opened to a predetermined angle, the control device operates the electromagnetic brakes 18 of the grip drive mechanisms 16A and 16B. As a result, the first grip portion 11A and the second grip portion 11B are locked in the open state.

Next, the control device drives the swing actuator 37 of the extension/contraction arm 15 to lock the position of the swing portion 32 with respect to the extension/contraction portion 33 at the initial position. Further, as shown in FIG. 6C, the control device drives the cylinder of the extension/contraction arm 15 to extend the extension/contraction portion 33 toward the article 100. Note that the operation of the grip portions 11A and 11B shown in FIG. 6B and the operation of the extension/contraction arm 15 shown in FIG. 6C may be performed at the same time.

Next, the control device controls the transfer robot 81 and brings the robot hand 1 closer to the article 100. Then, the control device drives the transfer robot 81 until the suction pad 14 of the robot hand 1 comes into contact with the article 100. As shown in FIG. 6D, when the suction pad 14 comes into contact with the article 100, the control device drives the negative pressure generator. As a result, the article 100 is sucked to the suction pad 14.

Further, in order to allow the article 100 to be reliably sucked with the suction pad 14, the suction pad 14 is pressed against the article 100. At this time, the swing actuator 37 is driven, and the swing portion 32 is locked at the initial position. For this reason, it is possible to prevent the swing portion 32 from swinging when the suction pad 14 is pressed against the article 100. Then, when the article 100 is sucked with the suction pad 14, the control device turns off the drive of the swing actuator 37 and unlocks the swing portion 32.

Next, as shown in FIG. 7A, the control device drives the cylinder of the extension/contraction arm 15 to contract the extension/contraction portion 33. Further, as shown in FIG. 7B, the control device controls the transfer robot 81 to raise the article 100 together with the robot hand 1. As a result, the article 100 is pulled out from the storage cardboard 200. Note that the contraction operation of the extension/contraction portion 33 shown in FIG. 7A and the ascending operation of the robot hand 1 by the transfer robot 81 shown in FIG. 7B may be performed at the same time. Alternatively, the contracting operation of the extension/contraction portion 33 may be performed after the ascending operation of the robot hand 1 is completed by the transfer robot 81.

Next, the control device turns off the electromagnetic brakes 18 of the grip drive mechanisms 16A and 16B, and drives the gripping actuator 17. Then, the grip portions 11A and 11B rotate in the direction of approaching each other, and the finger portion 22 comes into contact with the article 100. As a result, the grip portions 11A and 11B grip the article 100 with the first force. Note that the first force for gripping the article 100 is set to such a force that the article 100 is not deformed.

When a predetermined time elapses after the gripping actuator 17 is driven, the control device stops the drive of the gripping actuator 17 and drives the electromagnetic brake 18. In this manner, the grip portions 11A and 11B are locked while gripping the article 100. As a result, the article 100 is gripped by the grip portions 11A and 11B of the robot hand 1 with the second force.

As described above, as the gripping operation of the article 100 with the first force, which is a relatively weak force, is started, and, after a predetermined time elapses, the article 100 is locked with the second force. In this manner, with a simple configuration, the article 100 can be reliably gripped by the grip portions 11A and 11B without being damaged. As a result, it is possible to prevent the article 100 from falling off the robot hand 1 due to the centrifugal force and the inertial force generated when the article 100 is conveyed.

Furthermore, the grip drive mechanisms 16A and 16B are controlled only in two stages of the first force and the second force without complicated control such as feedback control using a pressure sensor. In this manner, the grip drive mechanisms 16A and 16B for moving the grip portions 11A and 11B can be easily controlled.

Further, the predetermined time, which is the timing for switching from the first force to the second force for driving the electromagnetic brake 18 as the locking mechanism, may be changed based on the size of the article 100. Therefore, for example, the size of the article 100 may be identified based on the image information obtained by the camera 85 photographing the article 100 and the information of the article 100 input in advance to the control device, and the control device may set the predetermined time, which is a timing for switching from the first force to the second force, according to the identified size of the article 100.

Note that, as described above, the distance between the finger portions 22 when the first grip portion 11A and the second grip portion 11B are closed can be adjusted according to the position of the arm support portion 23 with respect to the rotation portion 24. Therefore, by adjusting the distance between the finger portions 22 in advance according to the size of the article 100, the first force may be switched to the second force, that is, the electromagnetic brake 18 may be driven when the grip portions 11A and 11B are completely closed. As a result, the grip drive mechanisms 16A and 16B can be easily controlled.

Further, in the above-described example, the example in which the electromagnetic brake 18 is driven to lock the grip portions 11A and 11B when the predetermined time elapses is described. However, the present invention is not limited to this. For example, when detecting that a preset gripping force (the second force) is reached, the control device may drive the electromagnetic brake 18 to lock the grip portions 11A and 11B with the second force. As a result, the grip drive mechanisms 16A and 16B can be controlled without the need of obtaining information on the size of the article 100.

For the detection of the gripping force, a value of current flowing through the gripping actuator 17 may be used. Further, when a pneumatic negative pressure generator is used as the grip drive mechanisms 16A and 16B, the gripping force of the grip portions 11A and 11B may be detected by detection of the pressure of the air output from the negative pressure generator. Alternatively, a switch that operates in the closed state of the grip portions 11A and 11B may be provided, and the grip drive mechanisms 16A and 16B may be controlled so as to grip the article 100 with the second force when the switch is operated.

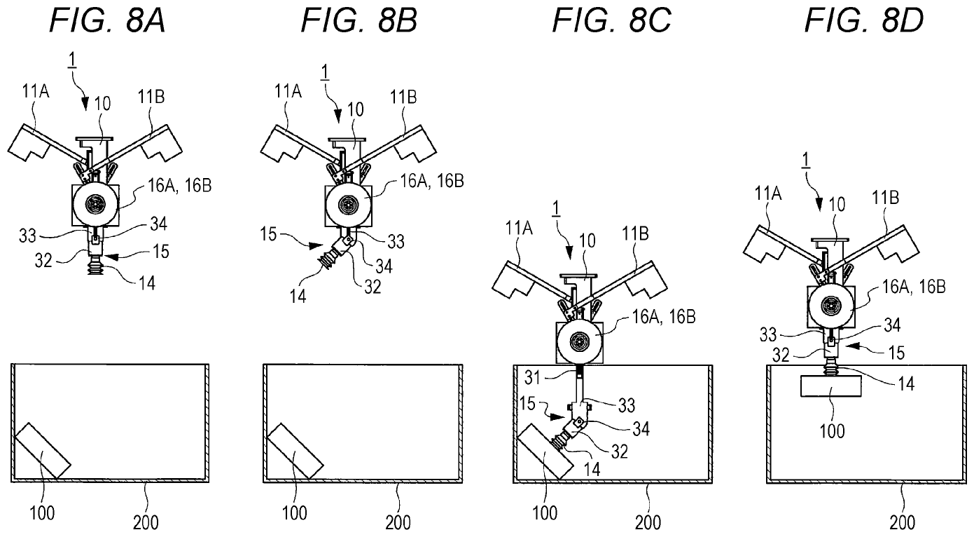

Next, another operation example of the picking system 80 will be described with reference to FIGS. 8A to 8D. FIGS. 8A to 8D are explanatory views showing another operation example of the picking system 80.

As shown in FIG. 8A, the article 100 to be sucked and gripped may be tilted in the storage cardboard 200. In order to reliably suck the article 100 with the suction pad 14, it is preferable to press the suction pad 14 perpendicularly to a suction surface of the article 100. Therefore, as shown in FIG. 8A, the control device first controls the grip drive mechanisms 16A and 16B to open the grip portions 11A and 11B. Then, the control device operates the electromagnetic brake 18 to lock the grip portions 11A and 11B in an open state.

Next, as shown in FIG. 8B, the control device drives the swing actuator 37 based on the image information from the camera 85, and swings the swing portion 32 until the direction of the suction pad 14 provided on the swing portion 32 becomes perpendicular to the suction surface of the article 100 to be sucked. Then, the control device controls the swing actuator 37 to lock the swing portion 32 at a position where the direction of the suction pad 14 is perpendicular to the suction surface of the article 100.

Next, as shown in FIG. 8C, the control device controls the transfer robot 81 and brings the robot hand 1 closer to the article 100. Then, the control device drives the transfer robot 81 until the suction pad 14 of the robot hand 1 comes into contact with the article 100. Further, the control device may drive the cylinder of the extension/contraction arm 15 to extend the extension/contraction portion 33.

Next, the control device controls the transfer robot 81 or the robot hand 1 to press the suction pad 14 to the suction surface of the article 100. Note that, since the position of the swing portion 32 is locked by the swing actuator 37, the suction pad 14 can be reliably pressed perpendicularly to the suction surface of the article 100. Then, the control device drives the negative pressure generator (not shown) to suck the article 100 with the suction pad 14.

When the suction of the article 100 with the suction pad 14 is completed, the control device turns off the drive of the swing actuator 37 and unlocks the swing portion 32. Then, as shown in FIG. 8D, the control device contracts the extension/contraction portion 33 of the extension/contraction arm 15, and controls the transfer robot 81 to raise the article 100 together with the robot hand 1. Since the swing portion 32 is unlocked, the swing portion 32 and the article 100 rotate about the swing shaft 34 due to their own weight. Therefore, the article 100 sucked on the swing portion 32 and the suction pad 14 faces downward in the vertical direction of the robot hand 1. After that, the control device controls the grip drive mechanisms 16A and 16B to grip the article 100 with the grip portions 11A and 11B. Note that the operation of gripping the article 100, which is the same as the operation shown in FIGS. 6A to 7C, will be omitted from description.

As described above, according to the robot hand 1 of the present embodiment, the tip portion of the extension/contraction arm 15 provided with the suction pad 14 swings according to the state in which the article 100 is placed, so that the article 100 can be reliably sucked and gripped.

Note that the present invention is not limited to the embodiment described above and shown in the drawings, and various modifications can be made within a range that does not deviate from the gist of the invention described in the claims.

In the above-described embodiment, the example in which the second force is generated by operation of the electromagnetic brake 18 which is a locking mechanism is described. However, the present invention is not limited to this. For example, by increasing the output of the gripping actuator 17, the first force may be changed to the second force.

Note that, although words such as “parallel” and “orthogonal” are used in the present description, these do not mean only “parallel” and “orthogonal” in a strict way, and may include “substantially parallel” and “substantially orthogonal” states within a range in which “parallel” and “orthogonal” are included and also their functions may be exhibited.

What is claimed is:

1. A robot hand, comprising:
a grip portion that grips an article;
a grip drive mechanism that moves the grip portion; and
a control device that controls drive of the grip drive mechanism, wherein
the control device controls drive of the grip drive mechanism to start gripping operation with a first force for a force of gripping the article by the grip portion, and then switches the force of gripping the article by the grip portion to a second force.

2. The robot hand according to claim 1, wherein
the control device controls the grip drive mechanism after a predetermined time elapses after gripping operation by the first force is started to switch from the first force to the second force.

3. The robot hand according to claim 2, wherein
the predetermined time is set according to size of the article.

4. The robot hand according to claim 2, wherein
the grip portion is supported so as to be openable and closable by the grip drive mechanism, and
the control device switches from the first force to the second force when the grip portion is closed.

5. The robot hand according to claim 1, wherein
when the force for gripping the article by the grip portion reaches the second force, the control device controls the grip drive mechanism to lock the grip portion at the second force.

6. The robot hand according to claim 5, wherein
the grip drive mechanism has a gripping actuator that moves the grip portion, and
the control device determines, from a value of current flowing through the gripping actuator, whether or not the force for gripping the article by the grip portion reaches the second force.

7. The robot hand according to claim 1, wherein
the grip drive mechanism includes a drive unit that moves the grip portion, and
a lock mechanism that locks movement of the grip portion by the drive unit, and
the control device switches the force for gripping the article by the grip portion from the first force to the second force by operating the lock mechanism.

8. The robot hand according to claim 1, further comprising:
a suction pad that sucks the article; and
an extension/contraction arm that is provided with the suction pad and can be expanded and contracted.

9. The robot hand according to claim 8, wherein
the extension/contraction arm includes
an extension/contraction portion, and
a swing portion that is swingably supported by the extension/contraction portion and is provided with the suction pad.

10. A picking system, comprising:
a transfer robot that conveys an article; and
a robot hand provided in the transfer robot, wherein
the robot hand includes
a grip portion that grips an article,
a grip drive mechanism that moves the grip portion, and
a control device that controls drive of the grip drive mechanism, and
the control device controls drive of the grip drive mechanism to start gripping operation with a first force for a force of gripping the article by the grip portion, and then locks the force of gripping the article by the grip portion with a second force.
